(19) United States
(12) Patent Application Publication
(10) Pub. No.: US 2009/0019437 A1
(43) Pub. Date: Jan. 15, 2009

(54) Application management and execution system and method thereof

(75) Inventors: Rongfeng Feng, Beijing (CN); Yang Lin, Beijing (CN); Min Hu, Beijing (CN); Kai Wang, Beijing (CN)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Lenovo (Beijing) Limited, Beijing (CN)

(21) Appl. No.: 12/215,783

(22) Filed: Jun. 30, 2008

(30) Foreign Application Priority Data
Jun. 29, 2007 (CN) 200710118187.5

(51) Int. Cl. G06F 9/455

(52) U.S. Cl. 718/1

(57) ABSTRACT

The invention discloses an application management and execution system and a method thereof. The application management and execution system comprises a virtual machine monitor for managing at least one virtual machine; the at least one virtual machine for processing at least one application, and storing, separately and respectively, application data used by each application and platform data required by the virtual machine for processing the application in one or more storage disk (persistent storage), and reading the application data and the platform data from the one or more storage devices respectively. The at least one application executing on the virtual machine may share the platform data in the one or more storage devices. When the virtual machine executes the at least one application, it may modify the application data in the storage devices.

### BACKGROUND OF THE INVENTION

1. Field of Invention

The present invention relates to a computer field, particularly to an application management and execution system, and a method thereof.

2. Description of Prior Art

As to applications with high security and high privacy such as network banks, network securities, a convictive and trusted execution environment is greatly desirable. Although banks and security manufactures have been making various efforts to enhance the security, it may be seen from a number of statistic data provided by the security manufactures since 2006, various kinds of malicious software against network banks and browsers still run riot willfully.

A current scheme 1 discloses that a separate virtual machine such as a VMware and an Intel TXT is established for applications.

The disadvantageous of this scheme is that hard disk space will be occupied too much, if one separate virtual machine is provided for each application; and a plurality of applications will influence each other, if the applications share one virtual machine. Damage caused by one application to a system may spread to all of other applications on the system.

A current solution 2 is that a key application is executed on a portable device. The disadvantageous of this scheme is that an original operating system is still used, and only configuration data on the portable device may be called. Thus the security is lower.

### SUMMARY OF THE INVENTION

For one or more problems as described above, an application management and execution system and a method thereof are provided by the present invention, which may provide a trusted environment, protect platform data and have a lower volume of storage. Thus there is no influence among the applications, which is easy to be maintained.

The application management and execution system according to the present invention comprises: a virtual machine manager for managing at least one virtual machine; the at least one virtual machine being operable for processing at least one application, and storing, separately and respectively, application data used by each application and platform data required by the virtual machine for processing the application in one or more storage devices, and reading the application data and the platform data from the one or more storage devices respectively.

In a case where the virtual machine and a normal operating system coexist, the application management and execution system further comprises monitoring means for monitoring installation and execution of the application, and selecting whether a safe mode is entered in which the application data and the platform data are stored respectively by the virtual machine when the normal operating system installs the application.

The at least one application executing on the virtual machine may share the platform data in the one or more storage devices. When the virtual machine executes the at least one application, it may modify the application data in the storage devices.

The application management and execution method according to the present invention may comprise steps of: storing in a virtual machine, separately and respectively, application data used by each application and platform data required by the virtual machine for processing the application in one or more storage devices in a case of application installation; and reading by the virtual machine the application data and the platform data from the storage devices respectively in a case that the application is executed; and modifying the application data during the execution.

In a case where the virtual machine and a normal operating system coexist, the virtual machine monitors installation and execution of the application, and prompts a user to select whether a safe mode is entered in which the application data and the platform data are stored respectively by the virtual machine before the application is installed.

In the present invention, the storage device for storing the platform data may be a readable and writable storage device. The storage device for storing the application data may be a readable and writable memory or a read-only memory

In the present invention, the application data and the platform data are stored separately. The platform data are highly protected (read-only, and may only be modified in a case of an authentification), and may be used by a plurality of applications altogether. The present invention enables a trusted environment to protect the platform data, so that the applications may not be influenced by each other. According to the present invention, less storage space is required and the platform data are shared, which are easy to be maintained and managed, and are easier to update and resume the operating system and the applications.

### BRIEF DESCRIPTION OF THE DRAWINGS

A further understanding of the present invention is provided referring to the drawings herein which constitute part of the application. Exemplary embodiments and the description thereof are intended to explain the present invention, which should not be considered as an appropriate limitation to the present invention. In the figures:

FIG. 1 is an illustrative block diagram of an application management and execution system according to the present invention;

FIG. 2 is a flowchart of an application management and execution method according to the present invention;

FIG. 3 is a flowchart illustrating a process for installing applications according to the present invention; and

FIG. 4 is a flowchart illustrating a process for execution applications according to the present invention.

### DETAILED DESCRIPTION OF PREFERRED EMBODIMENTS

Hereinafter, the present invention will be further described in detail by referring to the drawings and the embodiments in order to make the objects, technical scheme and advantages of the present invention more apparent.

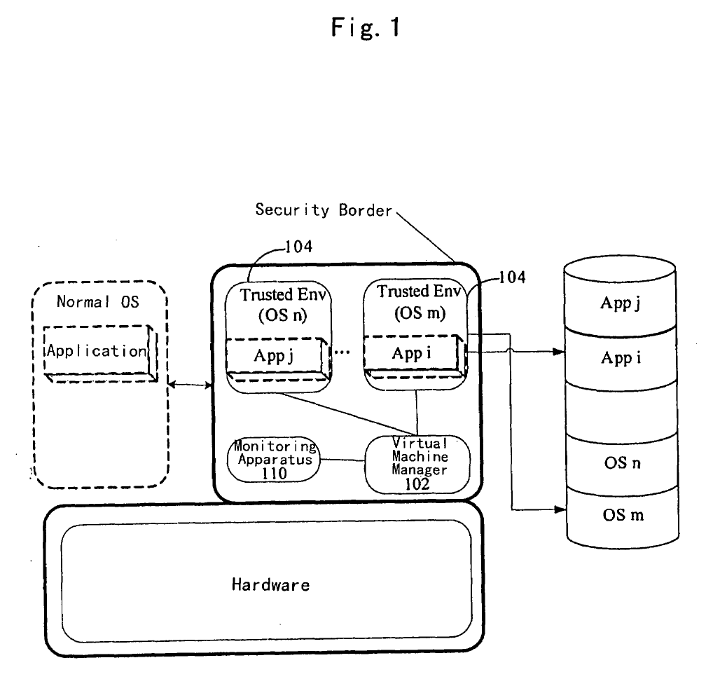

FIG. 1 is an illustrative block diagram of an application management and execution system according to the present invention. As shown in FIG. 1, the application management and execution system of the present invention comprises: a virtual machine manager 102 for managing at least one virtual machine; at least one virtual machine 104 for processing at least one application and storing, separately and respectively, application data used by each application and platform data required by the virtual machine for processing the application in one or more storage devices, and reading the application data and the platform data from the one or more storage devices respectively.

In a case where the virtual machine and a normal operating system coexist, the application management and execution system further comprises monitoring means 101 for monitoring installation and execution of the application, and selecting whether a safe mode is entered in which the application data and the platform data are stored respectively by the virtual machine when the normal operating system installs the application.

The at least one application executing on the virtual machine may share the platform data in the one or more storage devices. When the virtual machine executes the at least one application, it may modify the application data in the storage devices.

In the present invention, the storage device for storing the platform data may be a readable and writable memory. The storage device for storing the application data may be a readable and writable memory or a read-only memory. In particular, FIG. 1 may be a diagram illustrating a PC structure which supports a software security deployment and execution. In FIG. 1, a plurality of operating systems and applications may exist in a persistent storage area (such as a system hard disk). The virtual machine manager may be a Hypervisor, which may be allowed to run one or more trusted computing environments. The operating system m, n (OSm, OSn) are operating system data managed by the Hypervisor which generally are read-only unless there is an instruction indicating definitely to update the operating system. When the applications (App i and App j) are installed, an operating system platform should be selected. Installed data may be written to another storage area without modifying the operating system data.

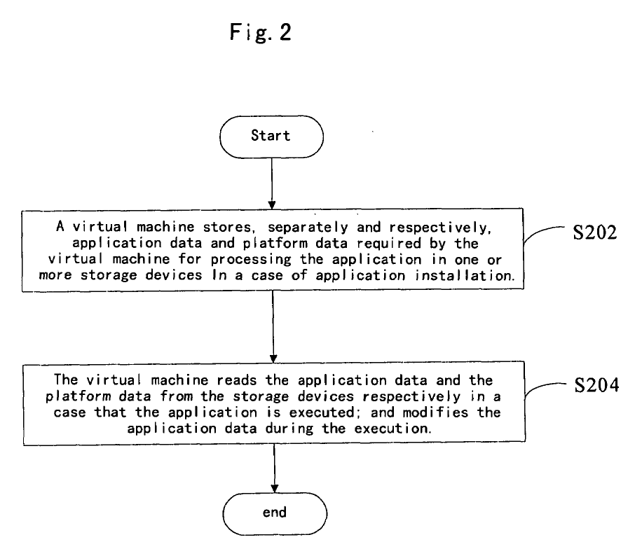

FIG. 2 is a flowchart of an application management and execution method according to the present invention. As shown in FIG. 2, the application management and execution method according to the present invention may comprise steps of: step 202 in which a virtual machine stores, separately and respectively, application data used by each application and platform data required by the virtual machine for processing the application in one or more storage devices in a case of application installation; and step 204 in which the virtual machine reads the application data and the platform data from the storage devices respectively in a case that the application is executed; and modifies the application data during the execution.

In a case where the virtual machine and a normal operating system coexist, the virtual machine monitors installation and execution of the application, and prompts a user to select whether a safe mode is entered in which the application data and the platform data are stored respectively by the virtual machine before the application is installed.

The application data and the platform data are stored separately, thus are easy to be maintained and managed (such as the updating and resumption of the operating system and application). The platform data may be used by a plurality of applications altogether which requires a less storage space. The platform data is highly protected (read-only, and may only be modified in a case of an authentification), which enables a trusted environment for executing the application and the applications not to be influenced by each other.

There may be a plurality of operating systems and applications in a system storage area. The virtual machine manager (Hypervisor) manages to be capable of running at least one operating system simultaneously. When the application is installed, it has to be decided which operating system should be selected to install the application. The Installed data and the application execution data are stored in another storage area without modifying the operating system data.

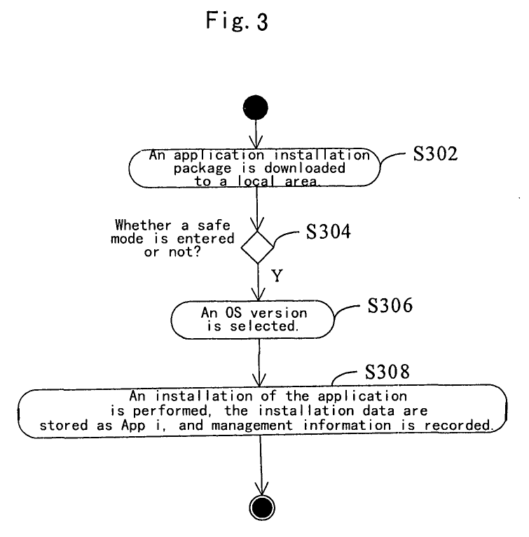

FIG. 3 is a flowchart illustrating a process for installing an application according to the present invention. As shown in FIG. 3, the process for installing the application comprises:

Step S302 for downloading an application installation package to a local area;

Step S304 for determining whether a safe mode is needed to be entered;

Step 306 for selecting a version of the operating system, if the safe mode is entered; and

Step 308 for performing an installation of the application, storing the application data in App i, and recording management information.

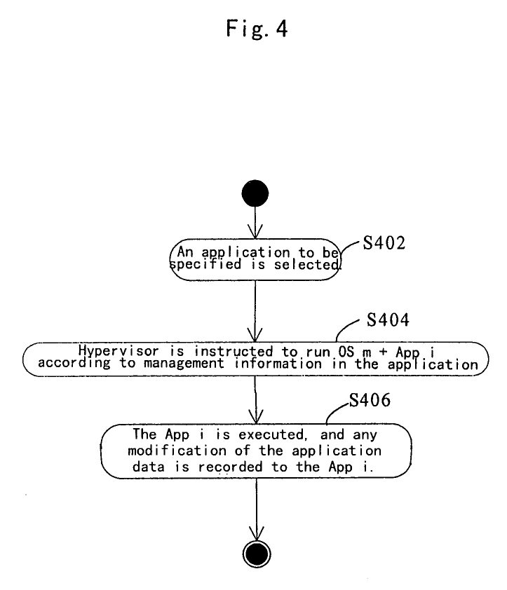

FIG. 4 is a flowchart illustrating a process for executing an application according to the present invention. As shown in FIG. 4, the process for executing the application comprises:

Step 402 for selecting an application to be selected;

Step 404 for instructing Hypervisor to run OS m and data in the App i according to management information in the application; and

Step 406 for executing the application and storing a modification of the application data to the App i.

Hereinafter, one embodiment of the present invention will be described in detail.

Hypervisor is implemented based on a virtual machine technique, which supports for scheduling and executing various operating systems and applications in one PC.

With well-known techniques, one monitoring module may be added to the operating system and Hypervisor. The monitoring software is installed and executed, so as to guarantee that any modification of data, during the installation and execution processes, may be saved in the application m instead of the operating system n. As to windows system, a dedicated module has to be deployed in the operating system to monitor a register, in consideration of the particularity of the register. The register problem has to be considered in view of a register item. The monitoring module should be deployed in the operating system.

One problem to be solved is how to combine the operating system and the application to be executed. Based on a patent US 2005240918, a virtual device is constructed by the virtual machine, and contents written to the device will finally be written to the App i area. During the installation process, a monitoring program in the operating system may write all of new installed files and modifications of the register to the virtual device. During the executing process, the monitoring program may read/write the virtual device preferentially.

In a separate PC, a storage architecture is built up in which the application data and the operating system are separated, so that a separated trusted computing environment is provided for the key application.

The advantages of this scheme are in that a trusted environment is able to be provided, the platform data is protected, the applications may not be influenced by each other, a less storage space is required, data are shared and easy to be maintained and management, and the operating system and the application may be updated and resumed easily.

The above is only the preferred embodiments of the present invention and the present invention is not limited to the above embodiments. Therefore, any modifications, substitutions and improvements to the present invention are possible without departing from the spirit and scope of the present invention.

1. An application management and execution system, comprising:
a virtual machine manager for managing at least one virtual machine;
the at least one virtual machine being operable for processing at least one application, and storing separately and respectively, application data used by each application and platform data required by the virtual machine for processing the application in one or more storage devices, and reading the application data and the platform data from the one or more storage devices respectively.

2. The application management and execution system according to claim 1, wherein the storage device for storing the platform data is a readable and writable memory.

3. The application management and execution system according to claim 1, wherein the storage device for storing the application data is a readable and writable memory or a read-only memory.

4. The application management and execution system according to claim 1, wherein in a case where the virtual machine and a normal operating system coexist, the application management and execution system further comprises: monitoring means for monitoring installation and execution of the application, and selecting whether a safe mode is entered in which the application data and the platform data are stored respectively by the virtual machine when the normal operating system installs the application.

5. The application management and execution system according to claim 4, wherein the at least one application executing on the virtual machine shares the platform data in the one or more storage devices.

6. The application management and execution system according to claim 5, wherein the application data in the storage devices are modified when the virtual machine executes the at least one application.

7. An application management and execution method, comprising steps of:
storing in a virtual machine, separately and respectively, application data and platform data required by the virtual machine for processing an application in one or more storage devices in a case of application installation; and
reading by the virtual machine the application data and the platform data from the storage devices respectively in a case that the application is executed; and
modifying the application data during the execution.

8. The application management and execution method according to claim 7, wherein the storage device for storing the platform data is a readable and writable memory.

9. The application management and execution method according to claim 7, wherein the storage device for storing the application data is a readable and writable memory or a read-only memory.

10. The application management and execution method according to claim 7, wherein in a case where the virtual machine and a normal operating system coexist, the virtual machine monitors installation and execution of the application, and prompts a user to select whether a safe mode is entered in which the application data and the platform data are stored respectively by the virtual machine before the application is installed.
